(19) United States
(12) Patent Application Publication
(10) Pub. No.: US 2020/0118142 A1
(43) Pub. Date: Apr. 16, 2020

(54) DEMAND AND SUPPLY TRACKING FOR INVENTORY MANAGEMENT AND REPLACEMENT OPTIMIZATION

(71) Applicant: MASSETTRACK, West Chester, PA (US)

(72) Inventors: Alfred Kariuki MUKUNYA, West Chester, PA (US); Thomas Todd TRINTER, Avondale, PA (US)

(73) Assignee: MASSETTRACK, West Chester, PA (US)

(21) Appl. No.: 16/626,020

(22) PCT Filed: Jun. 26, 2018
(86) PCT No.: PCT/US18/39487

§ 371 Date: Dec. 23, 2019

Related U.S. Application Data
(60) Provisional application No. 62/524,631, filed on Jun. 26, 2017.

(51) Int. Cl. G06Q 30/00; G06Q 30/02; G06F 16/903

(52) U.S. Cl. CPC G06Q 30/012; G06F 16/90335; G06Q 30/0283

(57) ABSTRACT

A system and method for determining whether to replace a consumer durable good (such as a washing machine, HVAC system or the like) in an environment where the price of the consumer durable good is continuously changing.

### CROSS REFERENCE TO RELATED APPLICATIONS

This application claims the benefit of U.S. provisional application No. 62/524,631 filed Jun. 26, 2017, which is incorporated by reference as if fully set forth herein.

### BACKGROUND

Individuals that operate multiple residential real estate properties are in a unique position to experience unexpected and unplanned repairs to consumer durable goods with limited life expectancies (e.g., furnaces, washing machines, hot water heaters, etc.). Such assets inevitably fail, however, it is the date of failure, repair, and subsequent replacement that cause the greatest hardship to owners and operators of residential properties. While emergency repairs or replacements can pose an imposition to the business, there are additional costs that come to owner and operators of residential properties. Costs related to labor are easily quantifiable while costs to the end user are not as easily discernible. Owners and operations of residential properties are forced to make decisions to repair or replace depreciable assets, and these decisions can occur at the most inopportune moments. Without knowledge of the effect of prevailing market prices in a particular geography, optimal times and prices for repair become a missed opportunity. Accordingly, it may be advantageous for there to exist some means by which owners and operators of residential properties may track and view assets and simultaneously view the prevailing market value.

Retailers of consumer durable goods utilize a complex promotional system throughout the year to price their products. In some cases, as a result of a holiday promotional sale (e.g., a “Black Friday Sale”), the retailer may even offer the durable good for less their own cost to entice consumers to come to their store and purchase other items. To make up for the lost profit during the promotional period, the retailer will often charge a premium for that same item in a different time period. As a result, the price of the same consumer durable good offered by the same retailer may fluctuate several hundred dollars throughout the year. Therefore, it is critical for a system that determines the replacement and repair schedule for consumer durable goods incorporate real-time pricing data.

Methods for tracking the depreciating of industrial assets are known in the art. For example, US Patent Publication 2014/0330749 A1 (Asset Lifecycle Management), US Patent Publication 2016/0132839 A1 (Systems and processes for facilities maintenance scheduling) and US Patent Publication 2013/0173325 A1 (Capital Asset Investment Planning Systems) teach methods of scheduling replacements of industrial machines (e.g., drill presses, pumps, and motors). These methods utilize a fixed replacement cost of the industrial asset. Using a fixed replacement cost for things like drill presses, pumps and monitors is appropriate because unlike with consumer durable goods, the prices of these industrial items remains constant throughout the year. As a result, it would be completely superfluous to consider the real-time pricing of these industrial assets. Therefore, these methods are unable to address the unique critical challenges of the price fluctuations associated with consumer durable goods.

In the context of consumer durable goods, some methods are known for scheduling warranty repairs. For example, US Patent Publication 2014/0101058A1 (SYSTEM AND METHOD FOR PROVIDING CONSUMER SIDE MAINTENANCE) and US Patent Publication 2006/0184379 A1 (Embedded Warranty Management) teach systems that use sensor data from the consumer durable good to schedule warranty service. These methods are completely silent concerning the replacement schedule of the durable good. As a result, these methods do not even consider the cost to replace the durable good instead of repairing the malfunctioning component.

The present system and methods, overcome the problems of the prior art and solve the technical problem of determining to replace a consumer durable good in an environment where the price of the consumer durable good is continuously changing.

### SUMMARY

This system uses technology to address a fundamental unmet need of asset owners and providers to track and know asset value at any time in order to make efficient repair/replacement decisions. The system provides a web-based, networked system to track the market holdings' current, book, and replacement values of depreciable items with tools to plan and predict related expenditures. The system provides a discrete geographic based (e.g. individual, household, business, regional, national, and a worldwide) current and projected demand and supply to create an efficient market of asset information.

The system provides for a ready secondary market for used assets, thus providing an asset owner the ability to simultaneously view and execute on the best of three alternatives on one dynamic interface—repair, trade-in, or discard a used asset. Currently, analyzing these three alternatives is a time-consuming process and performed highly inefficiently by the asset owner without having a dynamic tool to use to act on active or live market information.

The system generates a dynamic profile of the asset as it ages through time until actual replacement. This is done on assets inputted onto the system from the user interface by normalizing and aggregating key metrics. The aggregation can be done by type of asset, location, or by any other applicable type of user-desired criteria in the system.

The system is based on a modular, distributed, highly scaleable architecture capable of running on multiple platforms. Data collection and management is designed for efficiency to minimize impact on the network and system resources. This enables real-time pricing data of replacement consumer good to be aggregated in near real-time and correlated with depreciation of the dynamically determined aging schedule of the asset.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a diagram illustrating examples of users of embodiments of the system.

FIG. 2 is a diagram illustrating example sources of data that are used by embodiments of the system.

FIG. 3 is a block diagram of a computing system that may implement the functions of the system.

FIG. 4 is a process map of an example process for determining whether to replace the consumer durable good.

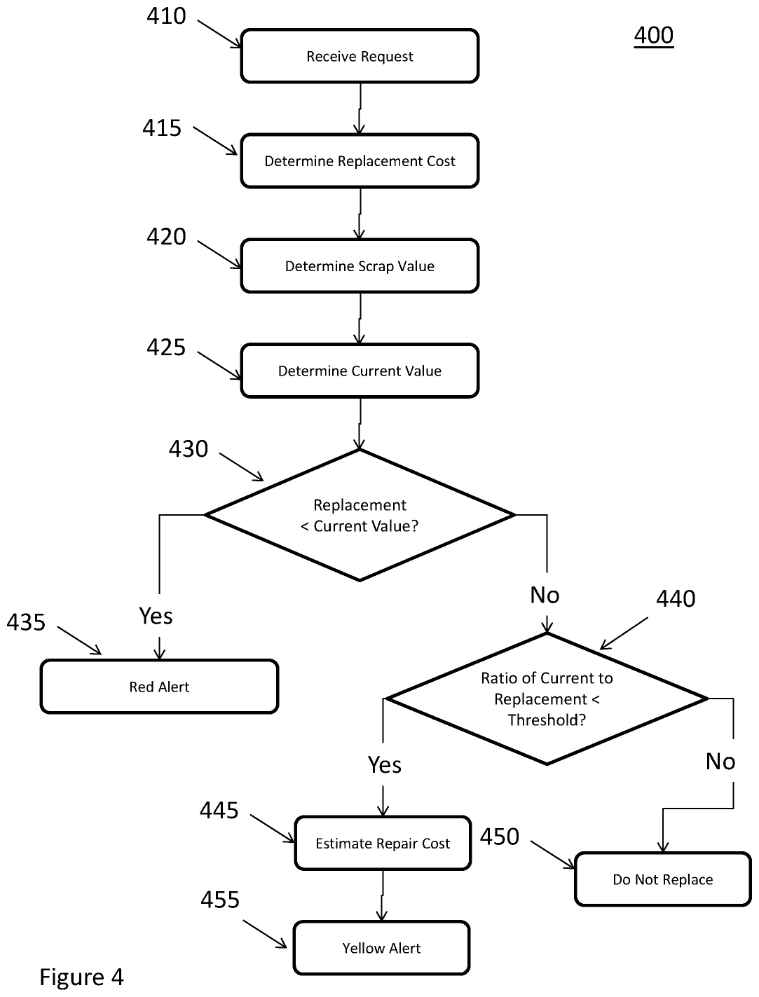

FIG. 5 is a process map of an example process for repairing the consumer durable good.

FIG. 6 is a process map of an example process for pricing a replacement consumer durable good.

FIG. 7 is an illustration of an example user interface that may be generated by the system.

### DETAILED DESCRIPTION

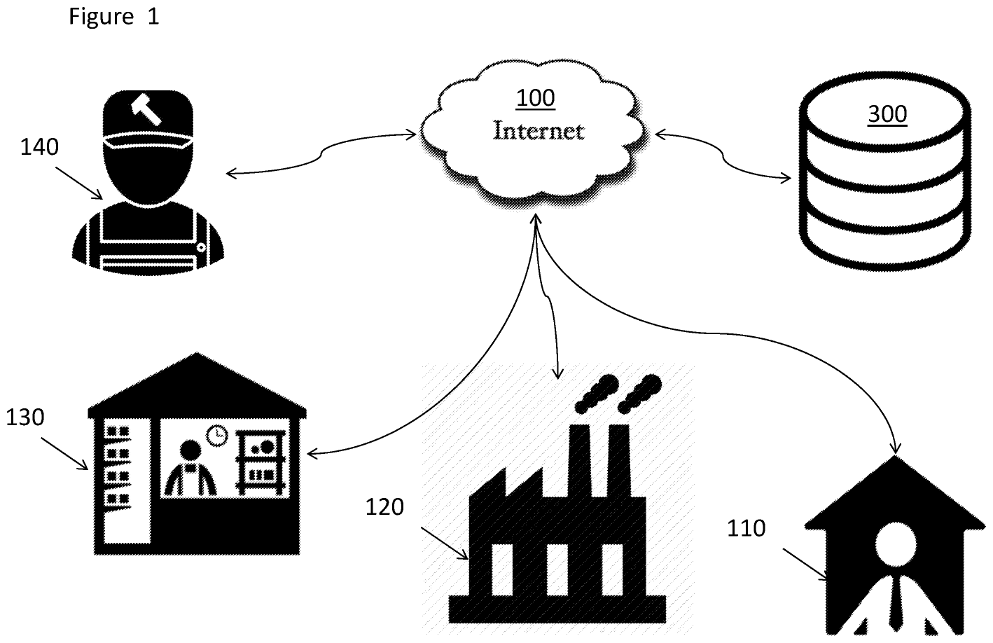

FIG. 1 is a diagram illustrating the users of the system 300. The system 300 may be accessed by an Owner 110 of the consumer durable goods 210. The consumer durable goods 210 may be a washing machine, dryer, dishwasher, furnace, hot water heater, HVAC system, oven or any similar consumer durable good that is a depreciable asset. The owner 110 may access the system 300 using a computer or mobile phone that is capable of connecting to the internet 100.

The system 300 may also be accessible to manufacturers 120 of the durable goods 210. The manufacturer 120 may access the system 300 to determine their production schedule or to identify what geographic location to ship their consumer durable goods 210. The system may also be accessed by retailers 130 of the durable goods 210. The retailers may access the system so they can target promotions at particular consumers or to predict future demand for the consumer durable goods 210. The system 300 may further be accessed by repair service providers 140 that can repair the durable goods 210. The repair service providers may use the system 300 to determine how to price their services or to identify particular consumers who may be in need of their services.

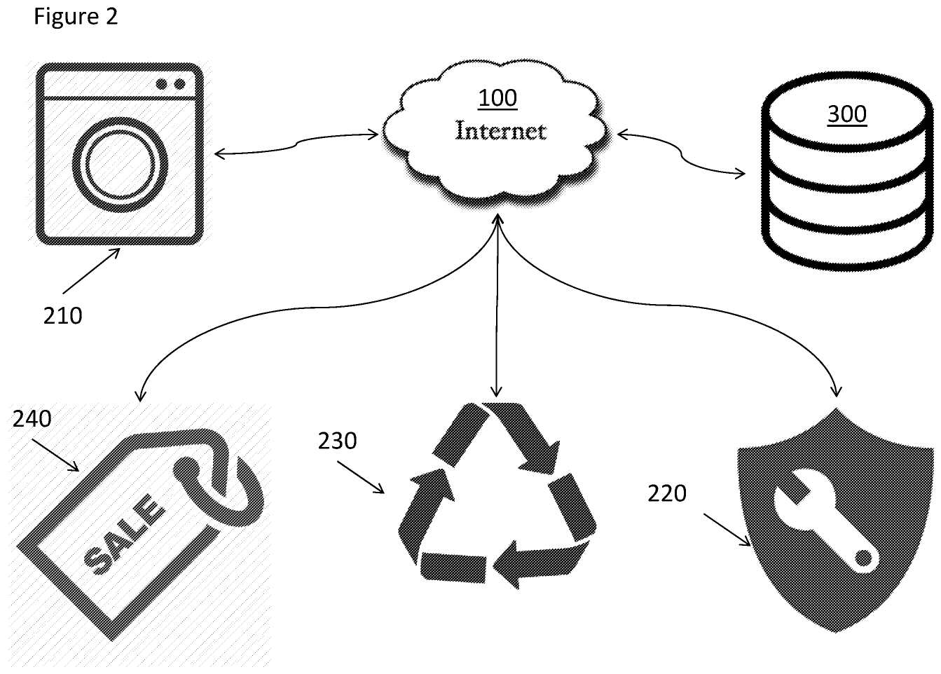

FIG. 2 is a diagram illustrating the distributed sources of data that may be utilized by the system 300. The system 300 may receive data from a database of warranty information 220 for the consumer durable good 210. This database may also be the U. S. Department of Energy's Compliance Certification Database which houses data submitted by manufacturers for covered consumer durable goods subject to Federal conservation standards. In some embodiments, information contained in the database of warranty information 220 may be provided by the manufacturers 120 or the retailers 130. The database of warranty information may include information on when repair work was need on a particular make and model of a durable good 210. The database of warranty information 220 may also contain information on how long the particular durable good 210 was used before being removed from service. In some additional embodiments, the database of warranty information 220 may include granular information such as the usage of the particular make and model of a durable good 210 before being removed from service. For instance, the information may highlight that a particular make and model of a dishwasher is often removed from service after 3,000 washing cycles. In addition, the information stored may also include the cost of various repairs that were made to the particular made and model of the consumer durable good. The system 300 may use the information contained in the database of warranty information 220 to predict the remaining useful life of the durable good 210.

The system 300 may also receive information from a salvage database 230. The salvage database 230 may contain information regarding the current resale value of a used durable good 210. This information may be obtained from existing marketplaces such as eBay or Craigslist. In addition, the salvage database 230 may include information regarding the current value of scrap metal in a particular geographic location. The system 300 may use the information contained in the salvage database to determine whether or not to replace the durable good.

A database of retail pricing information 240 is also accessible to the system 300 via the internet 100. The database of retail pricing information 240 contains the current price of the durable good 210 in a particular location. The retail pricing information database 240 may be dynamically updated by the retailer 130 using any electronic information protocol known in the art. Alternatively, the retail pricing information may be obtained from the public websites of the retailers 130. Techniques for extracting information from public websites are well known in the art and may include screen scraping or other similar techniques known in the art. In many embodiments, the pricing data contained in the database of retail pricing 240 is updated as soon as a change in pricing of the durable good occurs. As a result, the database of retail pricing 240 has an accurate price of the consumer durable good 210 that reflects any promotions or discounts applicable to the geographic location.

In some embodiments, the durable good 210 may transmit usage information back to the system 300 via the internet. The system 300 may use this information from the durable good 210 to improve the prediction of the remaining useful life of the durable good. However, in some embodiments, the durable good 210 is not required to communicate with the system 300.

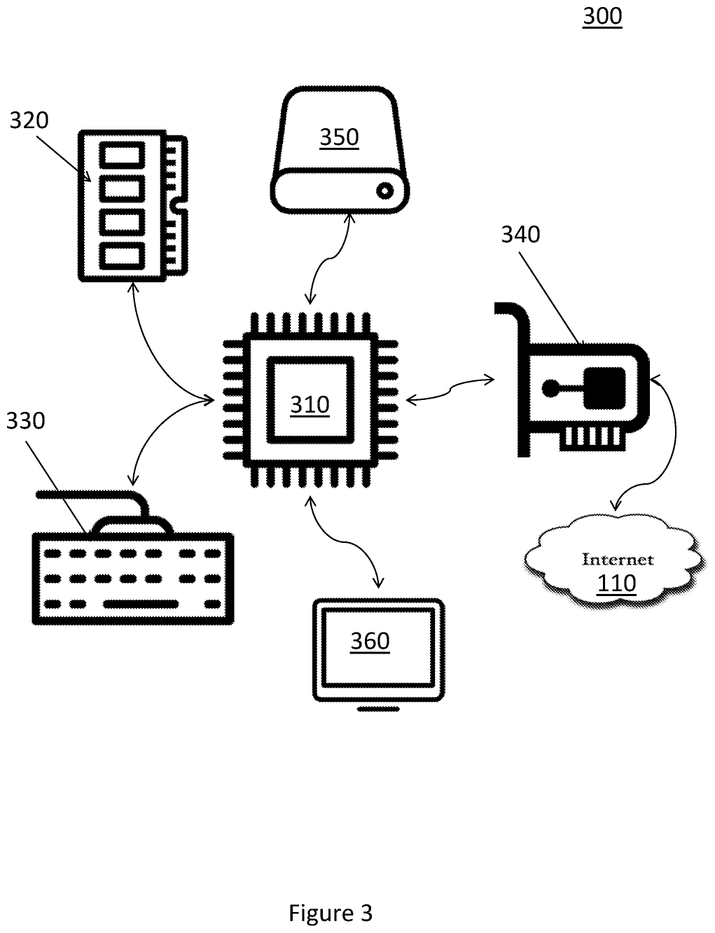

FIG. 3 is a block diagram of the system 300. The system includes a processor 310 that is connected to a network interface 340. The processor 310 may be of any form known in the art that is capable of executing predetermined instructions. The network interface 340 connects the system 300 to the internet 110, and the data sources illustrated in FIG. 2. The system 300 further includes a memory 320 that is located on the same die as the compute node or processor 310 or is located separately from the compute node or processor 310. In an implementation, the memory 320 includes a volatile or non-volatile memory, for example, random access memory (RAM), dynamic RAM, or a cache.

A storage 350 is also included in the system 300. The storage 350 includes a fixed or removable storage, for example, a hard disk drive, a solid state drive, an optical disk, or a flash drive. In some embodiments the storage 350 may be a network-based storage device or cloud storage. The storage 350 may store information related to the particular consumer durable goods 210 that are owned by a particular owner 110. This information may include the make and model of the durable good. It may also include the purchase price, purchase date, and warranty information. In addition, the storage 350 may store repair history of the particular durable good 210. Further, the storage 350 may save information that identifies the particular geographic location where the particular durable good 210 is installed. Information about the performance characteristics of the durable consumer good 210 may also be stored. In addition, the storage 350 may store information about the owners 110. This information may include the contact information including an email address or mobile phone number of the owner 110.

Also stored in the storage 350 are a plurality of rules for searching the database of warranty information 220. The plurality of rules may include rules for how to determine warranty information when the exact make and model are not found in the database of warranty information 220. The storage 350 may also store a plurality of rules for how to search the database of retail pricing information 240. These rules may specify a preference of a particular retailer or a predetermined distance away the particular retailer may be.

In in some embodiments, the system 300 may also include an input device 330. The input device 330 may be utilized to manually input information into the storage 350. In some embodiments, the input device 330 may be a website that that receives information that is remotely inputted by a user. In other embodiments, the input device 330 may be a keyboard or similar devices known in the art. The system 300 may also include an output 360. In some embodiments, the output 360 may be a website. In other embodiments, the output 360 may be a local display.

The system 300 may monitor the information contained in the database of warranty information 220, the salvage database 230, and database of retail pricing information 240. When new information is detected for a particular durable good, the process 400 of determining whether to replace a consumer durable good 210 that is performed. In step 410, the system 300 receives a request to determine whether or not to replace particular consumer durable goods 210. In some embodiments, the request may be automatically generated at a predetermined time interval. In other embodiments, the request may be automatically generated when the cost of the durable consumer good 210 has changed by a predetermined amount. In some cases, the request may be generated when new warranty information about the consumer durable good 210 becomes available in the database of warranty information 220. Similarly, the request may also be automatically be generated when new information becomes available in the salvage database 230. The request may also be generated by a user accessing a webpage via input device 330.

In step 415, the system then determines replacement costs of the particular consumer durable goods 210. The replacement cost may be determined by retrieving information from the storage 350 that identifies the make, model and geographic location of the particular durable good 210. The database of retail pricing information 240 is then searched to determine a current cost of replacing the durable good based on the information retrieved from the storage 350. The search of the database of retail pricing information 240 may utilize the plurality of rules stored in the storage 350. The plurality of rules may be used to retrieve pricing information from retailers that are located within a predetermined distance from the geographic location of the customer durable good. In some embodiments, the database of retail pricing information 240 may additionally be searched based on the performance characteristics of the consumer durable good (i.e., load capacity or number of BTUs). The system then determines the replacement cost by selecting the minimum price of a consumer durable good that matches the search criteria return by the database of retail pricing information 240. In some embodiments, the replacement cost calculated in step 415 is stored also saved in the storage 350.

In step 420, the scrap value of the particular consumer durable good 210 is then determined. The scrap value is determined by retrieving information salvage database 230 based on the information retrieved from the storage 350. In some embodiments, the salvage database is queried for values within a predetermined distance of the geographic location of the particular consumer durable good. The highest value returned by the search of the salvage database 230 is determined to be the scrap value. In some embodiments, the scrap value calculated in step 420 is stored also saved in the storage 350.

The current value of the asset is then determined in step 425. The current value is determined by retrieving additional information about the consumer durable good 210 from the storage 350. The additional information retrieved may include the age and number of cycles the particular consumer durable good 210. Then the database of warranty information 220 is queried for information for information regarding the particular durable good 210. In many embodiments, the database of warranty information 220 is searched according to the rules stored in the storage 350. The information from the database of warranty information 220 is then correlated to the information on the particular consumer durable good from the storage 350. The correlation process may consider the repair cost of the particular consumer durable good. The current value of the particular consumer durable good 210 is then determined based on the correlated information and the scrap value determined in step 420. In some embodiments, the current value calculated in step 425 is stored also saved in the storage 350.

The current value determined in step 425 is then compared in step 430 to the replacement cost determined in step 415. If the replacement cost is less than the current value, a red alert is generated in 435. In some embodiments, a red alert may include sending an email, or text message to the Owner 110 that indicates that the particular consumer durable good 210 needs to be replaced. The email or text message sent to the owner 110 may further include a link to a replacement durable good offered for sale by the retailer 130. The red alert may also include replacing the particular consumer durable good with a new consumer durable good. In some embodiments, the system 300 may send a message to the retailer 130 that alerts the retailer to a potential opportunity to sell a new consumer durable good to the owner 110. The red alert may also include automatically transmitting an order for a replacement consumer durable good to a retailer 130.

If in step 430, the current value is determined to be greater than the replacement cost, the system 300 may determine a ratio of the current value to the replacement value. The predetermined threshold may a value that is specific to the type of consumer durable good. For example, a relatively inexpensive dishwasher may have a different threshold than an expensive HVAC system.

If the ratio of the current value to the replacement value is less than the threshold, the system 300 then estimates the cost of repairing the consumer durable good 210 so that the ratio of current value to replacement cost satisfies the predetermined threshold in step 445. The estimated cost of repairing the consumer durable good may be calculated based on information contained in the database of warranty information 220 and the information stored in the storage 250. Then a yellow alert is generated in step 455. The yellow alert may include sending an email or text message to a repair service 140. The email or text message sent to the repair service 140 may indicate that the owner 110 may be in need of a repair of the particular consumer durable good. The message that is sent to the repair service 140 may include the estimated repair cost calculated in step 445. The yellow alert may also include sending a message to the owner 110. The message that is sent to the owner 110 may include the estimated repair cost calculated in step 445. The message that is sent to the owner 110 may also include a link to contact the repair service 140.

If in step 440, it is determined that ratio of current value to replacement cost is less than a threshold, the system 300 determines in step 450 that the particular consumer durable good 210 does not need to be replaced.

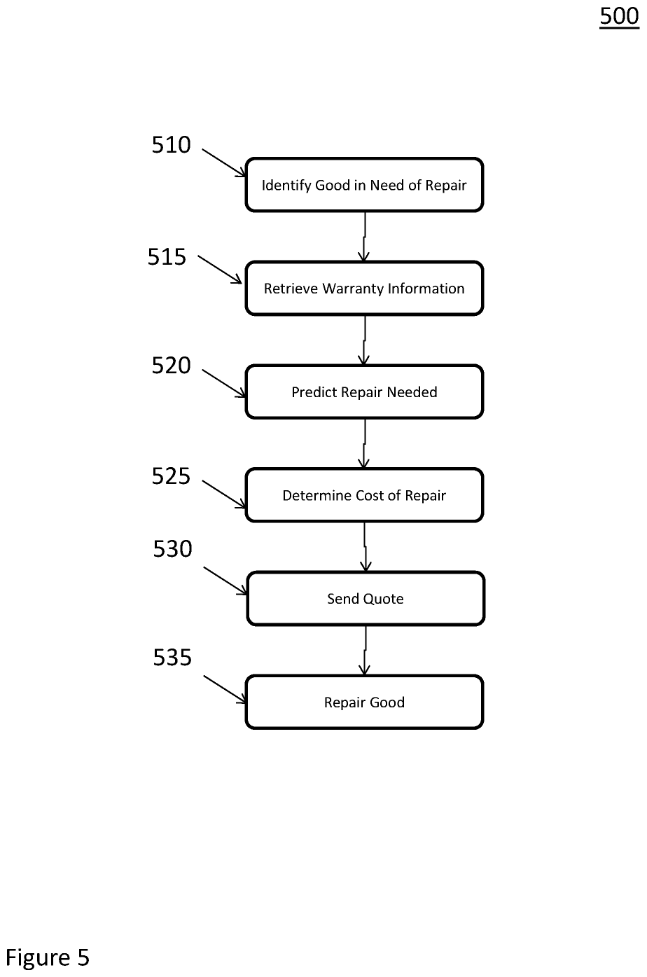

FIG. 5 is an example process 500 that may be utilized by the repair service 140. This process 500 may be automatically triggered when information contained in the database of warranty information 220, the salvage database 230, and database of retail pricing information 240 changes. In other embodiments, the process 500 may be triggered by the repair service 140 accessing a webpage through input device 330.

In step 510, the system identifies all of the consumer durable goods 210 in a particular geographic region that are in need of maintenance or repair based on the information stored in storage 350. The system 300 may determine that a particular consumer durable good is in need of maintenance or repair when the ratio of current value for the durable good to the replacement cost of the consumer durable good is less than a predetermined threshold. The replacement cost and the current value may be determined based upon the values saved in the storage 350 or may be dynamically determined in a similar manner as described in steps 415 and 425 respectively.

Then in step 515 warranty information from the warranty information database 220 is retrieved. The warranty information retrieved may indicate a list of the most common component failure for the particular consumer durable good 210. Then the particular type of repair that the consumer durable good 210 requires is predicted in step 520. The particular repair that is needed may be predicted based on the list of the most common components failure and the usage information of the particular consumer durable good stored in storage 350.

In step 525, the cost to repair the consumer durable good 210 is then determined. A quote to repair the consumer durable good is then generated and transmitted to the owner 110. The quote may be transmitted as an email or text message. The email or text message may contain a link that allows the owner 110 to accept the quote from the repair service 140. When the owner 110 accepts the quotation, the repair service then proceeds to repair the consumer durable good 210 in step 535.

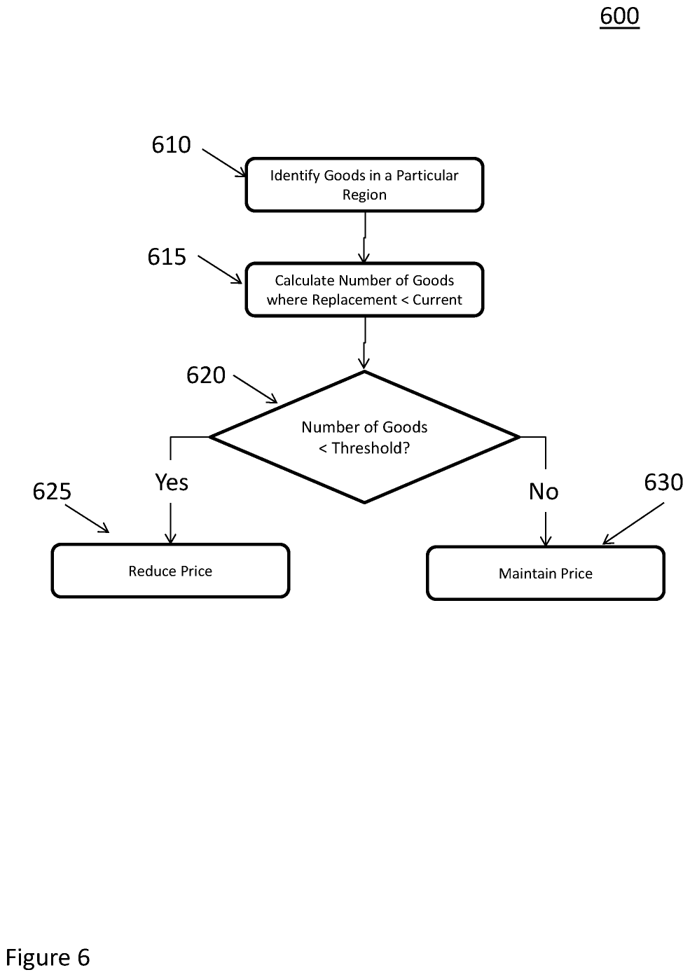

An illustration of an example process 600 that may be utilized by a manufacturer 120 or retailer 130 is illustrated in FIG. 6. This process 600 may be automatically triggered when information contained in the database of warranty information 220, the salvage database 230, and database of retail pricing information 240 changes. In other embodiments, the process 600 may be triggered by the manufacturer 120 or retailer 130 accessing a webpage through input device 330.

In step 610, consumer durable goods that are located within a particular geographic region are identified based on information saved in storage 350. Then in step 615, a number of goods that have a replacement cost that is less than a current value is calculated. The replacement cost and the current value may be determined based upon the values saved in the storage 350 or may be dynamically determined in a similar manner as described in steps 415 and 425 respectively.

Then in step 620, the number of consumer durable goods calculated in step 615 is compared to a threshold. If the threshold is not exceeded, this suggests more owners 110 of the consumer durable good 210 will decide to keep their existing consumer durable 210. As a result, in step 625 the price of the consumer durable good is lowered. In many embodiments, the lowered price information is automatically transmitted to the database of retail pricing 240. In some cases, the manufacturer 120 will respond by producing or shipping fewer consumer durable goods to the particular geographic region. If it is determined in step 620, that the number of consumer durable goods calculated in step 615 exceeds the threshold, this implies that there is sufficient replacement demand for replacement durable goods that are offered by the retailer 130. As a result, in step 630 the price of the replacement durable good is maintained. In addition, in step 620, the system may automatically generate an email or text message to the owner 110 of the consumer durable goods where replacement cost is less than the current value of the consumer durable good. This email or text message may include a link for the owner 110 to click to purchase a replacement consumer durable good.

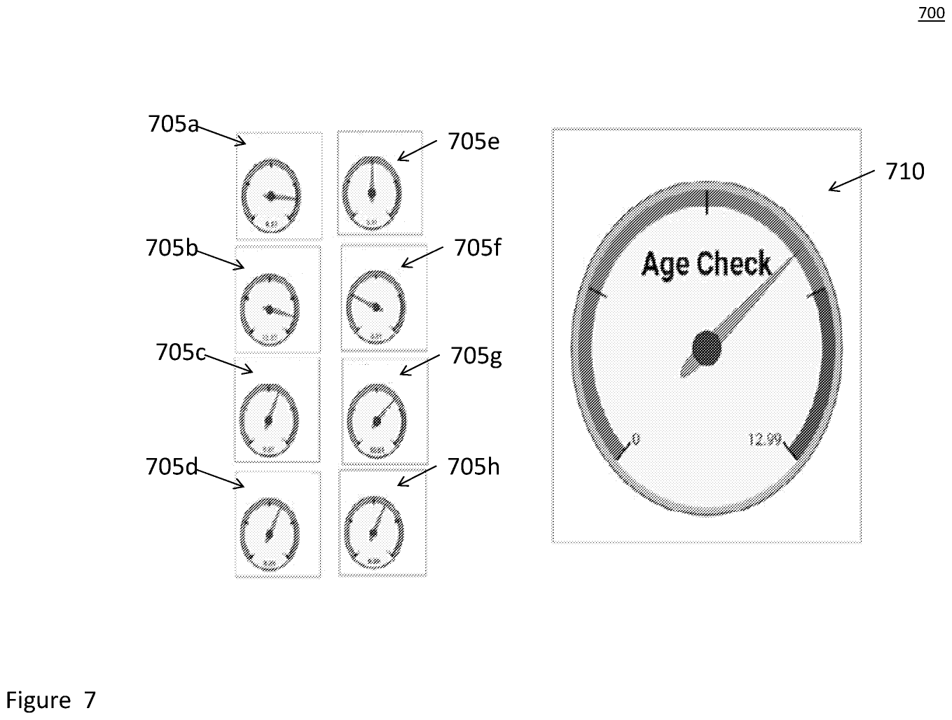

FIG. 7 depicts an example User Interface 700 that may be displayed on output 360. The example user interface 700 includes dial displays for 705A-70H for each of a plurality of consumer durable goods that are installed at a geographic location that is managed by the owner 110. The information displayed on the dial displays 705A-705H are determined based on the ratio of current value to replacement cost determined in step 440. The user interface may include a building age indicator 710. The building age indicator 710 may be determined based on the information displayed on the dial displays 505A-505H.

In addition, the features and elements described in these illustrations focus on consumer durable goods. There are many alternative ways of implementing the invention and it is not limited to the details provided. Owners of any other types of assets, for example, personal property, also need to track their assets using combinations or sub-combinations of features described herein.

Although features and elements are described above in particular combinations, one of ordinary skill in the art will appreciate that each feature or element can be used alone or in any combination with the other features and elements. In addition, a person skilled in the art would appreciate that certain steps can be reordered or omitted.

Furthermore, the methods described herein may be implemented in a computer program, software, or firmware incorporated in a computer-readable medium for execution by a computer or processor. Examples of computer-readable media include electronic signals (transmitted over wired or wireless connections) and non-transitory computer-readable storage media. Examples of non-transitory computer-readable storage media include, but are not limited to, a read-only memory (ROM), a random access memory (RAM), a register, cache memory, semiconductor memory devices, magnetic media, such as internal hard disks and removable disks, magneto-optical media, and optical media such as CD-ROM disks, and digital versatile disks (DVDs).

What is claimed is:

1. A method for replacing a consumer durable good, the method comprising:
receiving an input that identifies a particular consumer durable good;
retrieving information and rules for the particular durable good from a memory, wherein the rules include a first plurality of rules for searching a first database and second plurality of rules for searching a second database;
searching the first database for current pricing information on a replacement consumer durable good based upon the first plurality of rules;
determining a replacement cost for the particular durable consumer durable good based on the current pricing information;
searching the second database for warranty information on the particular consumer durable good based upon the second plurality of rules;
determining a current value of the particular durable consumer good by correlating the warranty information with the information about the particular durable good;
comparing the current value of the particular durable consumer good to the replacement cost; and
replacing the particular consumer durable good with the replacement consumer durable good when the current value of the particular durable consumer good is less than the replacement cost.

2. The method of claim 1, further comprising:
searching a third database for a salvage value of the particular consumer durable good;
wherein the current value of the particular durable consumer good is further determined based upon the salvage value.

3. The method of claim 1, further comprising:
automatically sending an email message to a user when the current value of the particular durable consumer good is less than the replacement cost.

4. The method of claim 1, further comprising:
calculating a ratio of the current value and the replacement cost of the particular durable consumer good; and
automatically sending an email message to a user when the ratio is less than a predetermined threshold.

5. The method of claim 1, wherein the consumer durable good is at least one of a washing machine, a drier, a dishwasher, hot water heater, furnace or Heating Ventilation Air Conditioning System (HVAC) system.

6. A system for replacing a consumer durable good, the system comprising:
a network interface that is communicatively coupled to a first database and a second database via a network;
a storage that stores a first plurality of rules for searching the first database and a second plurality of rules for searching the second database; and
a processor communicatively coupled to the network interface and the storage, wherein the processor:
receives, using the network interface, an input that identified a particular consumer durable good,
retrieves, from the storage, information and rules for the particular durable good, wherein the rules include the first plurality of rules and the second plurality of rules that are specific to the particular durable good,
searches, using the network interface, for current pricing information on a replacement consumer durable good based upon the first plurality of rules;
determines a replacement cost for the particular durable consumer durable good based on the current pricing information;
searches, using the network interface, the second database for warranty information on the particular consumer durable good based upon the second plurality of rules;
determines a current value of the particular durable consumer good by correlating the warranty information with the information about the particular durable good;
compares the current value of the particular durable consumer good to the replacement cost; and
causes the particular consumer durable good to be replaced with the replacement consumer durable good when the current value of the particular durable consumer good is less than the replacement cost.

7. The system of claim 6, wherein the processor further:
searches, using the network interface, a third database for a salvage value of the particular consumer durable good;
wherein the current value of the particular durable consumer good is further determined based upon the salvage value.

8. The system of claim 6, wherein the processor further:
automatically sends, using the network interface, an email message to a user when the current value of the particular durable consumer good is less than the replacement cost.

9. The system of claim 6, wherein the processor further:
calculates a ratio of the current value and the replacement cost of the particular durable consumer good; and
automatically sends, using the network interface, an email message to a user when the ratio is less than a predetermined threshold.

10. The system of claim 6, wherein the consumer durable good is at least one of a washing machine, a drier, a dishwasher, hot water heater, furnace or Heating Ventilation Air Conditioning System (HVAC) system.
